(19) United States
(12) Patent Application Publication
(10) Pub. No.: US 2007/0152630 A1
(43) Pub. Date: Jul. 5, 2007

(54) Methods and devices for battery hot swapping

(76) Inventors: David A. Winkler, Spring Grove, IL (US); Mark A. Barabolak, Elmhurst, IL (US); Bokchain Koh, Crystal Lake, IL (US); Arthur C. Leyh, Spring Grove, IL (US); Edward A. Naddeo, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 11/321,308

(22) Filed: Dec. 29, 2005

(51) Int. Cl. H02J 7/00

(52) U.S. Cl. 320/110

(57) ABSTRACT

Disclosed are methods and devices in a battery powered electronic device (202) for hot swapping batteries, the battery powered electronic device having a battery holder (210) with a first connector (203) and a second connector (205), and having a first battery (204) in contact with both the first connector (203) and the second connector (205). The method includes maintaining power to the device from a first battery (706). The method also includes partially moving the first battery out of the battery holder in a predetermined direction to break contact with the first connector (712) while maintaining contact with the second connector (714). The method further includes partially inserting a second battery into the battery holder in the predetermined direction so that the second battery is received by the battery holder and makes contact with the first connector (712). In another embodiment the method includes charging one or another battery through the first connector or the second connector.

### FIELD

This disclosure relates in general to portable power devices, and more particularly to battery replacement without loss of power to an electronic device.

### BACKGROUND

The makers of mobile communication devices, including those of cellular telephones, are increasingly adding functionality to their devices. For example, cellular telephones include features such as still and video cameras, video streaming and two-way video calling, email functionality, Internet browsers, music players, FM radios with stereo audio, and organizers. Bluetooth enabled cellular telephones may be PC compatible so that files generated or captured on the mobile communication device may be downloaded to a PC. Likewise, data from a PC or other source may be uploaded to the mobile communication device. Cellular telephones in particular are becoming more than simply mobile communication devices. They are evolving into powerful tools for information management.

With the increased functionality of mobile communication devices, users are more likely to consume significant power for extended periods of time. At the same time consumers welcome increased functionality in mobile communication devices, consumers also prefer smaller sized mobile communication devices. In the meantime though, the power burden has outpaced battery technology. Accordingly and unfortunately small batteries cannot store enough power to maintain functionality for extended periods of time.

As users tend to use their devices for extended periods of time, interruptions due to depleted batteries can be extremely inconvenient. A user may not have immediate access to an electrical outlet or car lighter to recharge the device battery. In the event that a user is able to attach a charger to the device, a charger can restrain the user's mobility. With a loss of power, a user may be forced to turn off the mobile communication device either intentionally or inadvertently. In this way, a voice or video call could be inconveniently interrupted. After the device is off, a user may change discharged batteries and then restore power to the device. When power is restored, a high functionality “smart” device may take over a minute to reboot and become operational.

In a high current drain device, such as a hand held cellular telephone, it would be beneficial to enable a user to hot swap device batteries. That is, users would benefit from continuous operability were batteries exchangeable in a device without loss of power to the device.

### BRIEF DESCRIPTION OF THE DRAWINGS

FIG. 1 depicts a battery powered electronic device in rear view in accordance with an embodiment, and in particular a cellular telephone having a battery positioned in its battery holder with one way tabs to engage unidirectional battery movement;

FIG. 2 depicts a device similar to that shown in FIG. 1, having two batteries positioned within the housing;

FIG. 3 depicts a device similar to those devices shown in FIGS. 1 and 2, however in FIG. 3 the battery holder is depicted as empty;

FIG. 4 depicts a battery in accordance with an embodiment having elongate contacts in two views, the first so that its bottom side is facing up on the drawing and the second a side view;

FIG. 5 depicts a battery powered electronic device in accordance with an embodiment in back view and side view having an empty battery holder;

FIG. 6 depicts an embodiment of a battery in accordance with another embodiment having c-clip contacts in two views, the first so that its bottom side is facing up on the drawing and the second a side view;

FIG. 7 is a flowchart showing an embodiment of a process for making and breaking connections of the batteries' contacts to the connectors of the battery holder during hot swapping;

FIG. 8 shows an embodiment of the connectors of the circuit in the battery holder along with other circuit components;

FIG. 9 shows an embodiment of a circuit where logic components may provide charger functions to one or two batteries in the device battery holder; and

FIG. 10 shows schematically four different configurations of batteries in a battery holder in accordance with an embodiment.

### DETAILED DESCRIPTION

Described are methods and devices in a battery powered electronic device for hot swapping batteries. That is, a user may maintain the power and thus operations of the device while exchanging a first battery for a second battery therein. Accordingly, without powering down the device, its current battery may be removed and replaced by another.

The device includes a battery holder or housing with at least two battery connectors and a circuit for providing continuous power to the device during a battery swap. To initiate the battery swap, the first battery is partially moved out of the battery holder in a predetermined direction to break contact with a first connector while maintaining contact with a second connector. To further the swap, the second battery is partially inserted into the battery holder in the predetermined direction so that the second battery is received by the battery holder and makes contact with the first connector. In one embodiment when the second battery moves in the predetermined direction within the battery holder, it pushes the first battery to effect the partial moving of the first battery out of the battery holder. Each battery is configured to maintain contact with one of the battery connectors substantially simultaneously during the replacement process.

In one embodiment, a circuit of the device includes battery connectors for the first and second batteries that can be configured with a charger circuit for charging the first battery while the first battery is partially removed from the battery holder, and for charging the second battery while the second battery is partially received into the battery holder, in either order.

The battery configuration, in one embodiment, includes contacts that are elongate contacts located on the bottom side of the first battery or located on the lateral sides of the battery. In another embodiment, the battery configuration includes c-clip contacts configured to make contact with connectors on the inside walls of the battery holder.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

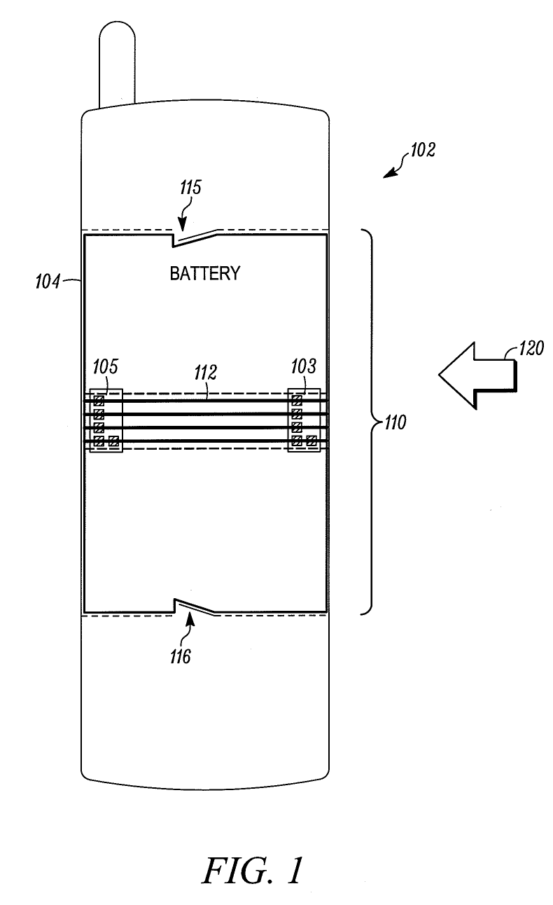

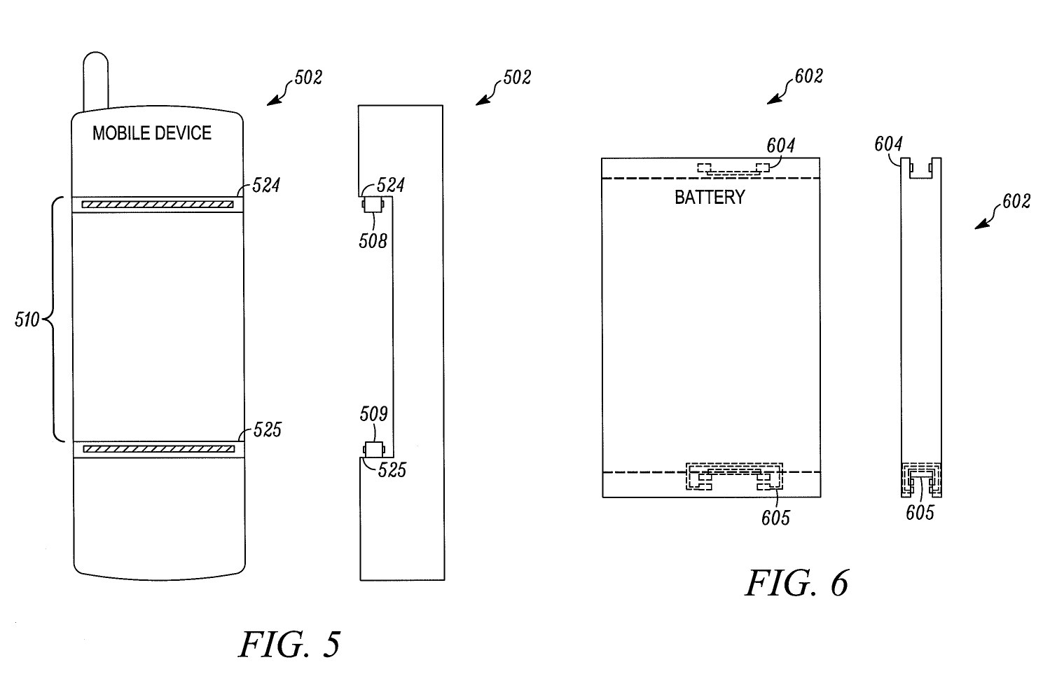

FIGS. 1, 2, and 3 are similar illustrations depicting battery housings on the back side of an embodiment of a battery powered electronic device. FIG. 5 shows an alternate embodiment for a battery housing of a battery powered electronic device. FIGS. 4 and 6 show bottom and side views of certain embodiments of batteries that can be adapted to fit the illustrated battery housings. The front side (not shown) of the mobile communication device may have a keypad and a display screen plus control elements.

FIG. 1 depicts a battery powered electronic device 102 in accordance with an embodiment having a battery 104 positioned in its battery holder 110 with one way tabs 115, 116 to engage unidirectional battery movement 120. The battery powered electronic device 102 can be a mobile communication device, and in particular, a cellular telephone. It is understood that any battery powered electronic device, including those that are not mobile communication devices, are within the scope of this discussion. Accordingly, the battery powered electronic device 102 can include, for example, cellular telephones, messaging devices, mobile telephones, personal digital assistants (PDAs), notebook or laptop computers incorporating communication modems, mobile data terminals, music players, application specific gaming devices, and video gaming devices incorporating wireless modems.

The device 102 is shown with a single battery 104 positioned in the device battery holder or housing 110. Two battery connectors 103 and 105 of the device 102 and the battery contacts 112 of the battery 104 are shown in phantom and will be discussed in detail below. The battery holder 110 can be in any suitable configuration recessed or not, and can be adapted to provide mechanical latching 115 and/or 116 to engage the battery 104 in the predetermined direction 120 and to engage a second battery in the predetermined direction 120. The mechanical latching can be a spring or tension tab that prevents the battery from being moved, in the instant embodiment, to the right. The battery may be allowed to move linearly in a direction to the left. Of course, depending upon the device battery housing design, the direction of movement of the battery may be in any unidirectional manner, for example, from left to right or down or up. It is further understood that any type of latching mechanism to engage the first battery in the predetermined direction and to engage the second battery in the predetermined direction is within the scope of this discussion.

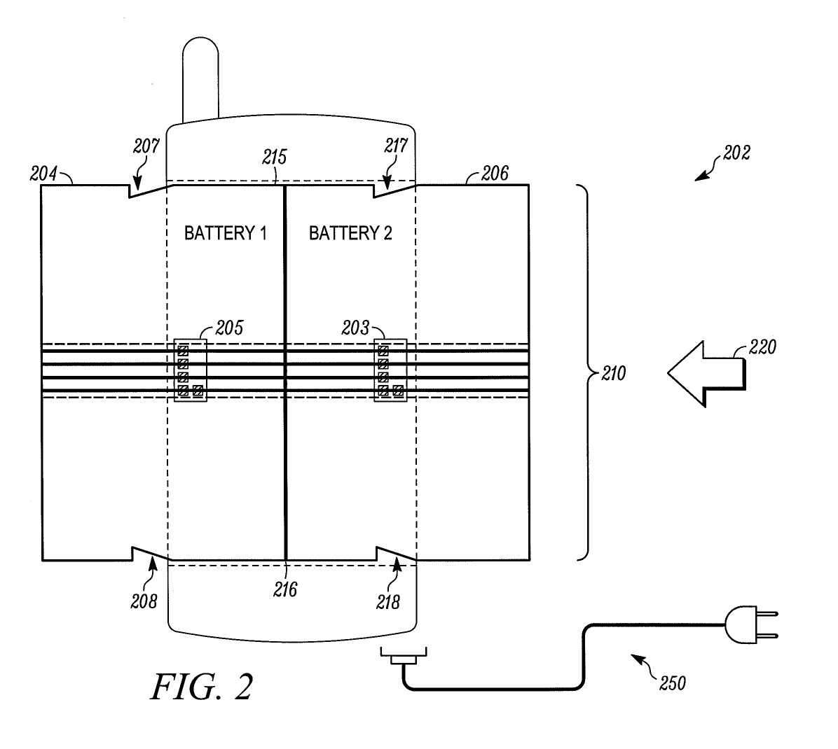

FIG. 2 depicts a device 202 similar to that shown in FIG. 1, having two batteries 204 and 206 positioned within the housing 210. With unidirectional motion 220 compelled by one or more mechanical latches 215, 216, a first battery 204 may be partially removed or partially moved out of the housing 210 in a predetermined direction 220 so that it can maintain contact with the second connector 205 (shown in phantom). A second battery 206 may be partially inserted or partially moved into the housing 210 in the predetermined direction 220 so that it can make contact with the first connector 203 (shown in phantom).

In FIG. 2, the mechanical latches 215, 216 are shown in a depressed state since neither is engaged by the batteries' latch receivers 207, 208, 217, 218. Were the first battery 204 to reverse direction from moving to the left to moving to the right, the battery latch receivers 207, 208 could engage the mechanical latches 215, 216 and could be stopped from further motion to the right. Also shown in FIG. 2 is a charger adapter 250 that will be discussed in more detail below.

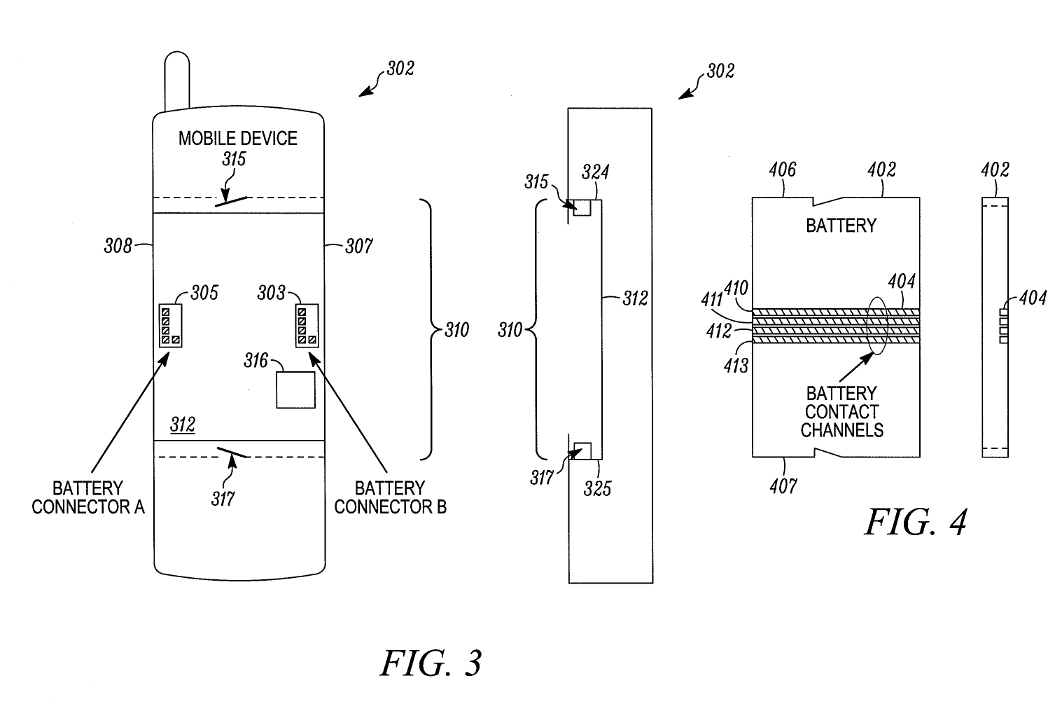

FIG. 3 depicts a device 302 that can be similar to devices 102, 202 shown in FIGS. 1 and 2, however, in FIG. 3 the battery holder 310 is depicted as empty. In FIG. 3, latches 315, 317 are depicted as well. A first connector 303 and a second connector 305 (see FIG. 1 connectors 103 and 105, and FIG. 2 connectors 203 and 205, respectively) are configured to provide power to the device's power circuit from a first battery that can be fully inserted into the device battery holder. The battery can be in contact with both the first connector 303 and the second connector 305 (see FIG. 1). Then by partially moving the first battery out of the battery holder 310 in a predetermined direction, the first battery breaks contact with the first connector 303 while maintaining contact with the second connector 305. A second battery can be partially inserted into the battery holder in the predetermined direction so that the second battery can be received by the battery holder and make contact with the first connector 303 (see FIG. 2). Afterward, the first battery may be moved out of the battery housing entirely so that the second battery can be fully inserted into the battery holder. Thus the second battery can replace the first battery, and the second battery can therefore make contact with both the first connector 303 and the second connector 305.

FIG. 3 also shows a side view of the device 302. A battery holder, housing or recess 310 has two open ends 307 and 308 to receive and expel the batteries by sliding the batteries through the holder 310 from, for example, the right side of the device open end 307 to the left side of the device open end 308. The side view illustrates the bottom 312 and the side walls 324, 325 of the battery holder. The back view also illustrates the bottom of the housing 312.

The lower right corner of the bottom 312 of the housing includes an optional lift up or sliding door 316 that covers, for example, the device's SIM card. As mentioned above, by partially moving, that is, partial removal of, the first battery out of the battery holder in a predetermined direction, the first battery may break contact with the first connector 303 while maintaining contact with the second connector 305. With the first battery partially removed and without inserting a second battery, the door 316 may be accessed and opened. Accordingly, a user may be able to replace a SIM card without powering down the device since the first battery can be supplying power to the device through the second connector 305. Once the SIM card operation is complete, the first battery may be fully reinserted, that is, moved back into the position shown in FIG. 1.

FIG. 4 depicts two view of a battery 402 in accordance with an embodiment having elongate contacts 404. The first view shows its bottom side facing up on the drawing and the second view is a side view. The battery 402 having elongate contacts 404 is configured to provide power to the first connector 303 and the second connector 305 of the device 302 shown in FIG. 3. The elongate contacts 404 can be on the bottom of the battery and can span the distance between a first connector 303 and a second connector 305 when the battery 402 is fully positioned in the battery holder 310. In another embodiment, the similarly configured elongate contacts of a battery are located on one or more lateral sides of the battery 406, 407. In such a configuration, the elongate contacts can make surface contact with an inside wall of the battery holder and/or connectors thereon (see FIG. 3, 324, 325) where the device's battery connector or connectors are located. In an embodiment with battery connectors configured on the inside walls of the battery holder, a different arrangement for compelling unidirectional motion may include, for example, mechanical latching on the bottom side (see FIG. 3, 312) of the battery holder.

The elongate contacts 404 may be disposed in parallel battery contact channels 410, 411, 412, 413. Corresponding contacts may be disposed in a first battery connector 303 and a second battery connector 305. Each of the corresponding contacts may be adapted to slide along, and make contact with, an appropriate elongate contact 404 disposed in a battery contact channel 410, 411, 412, 413. While the elongate contacts 404 are depicted as extending the width of the battery, it may suffice that their length reaches the span of the connectors 303 and 305.

FIG. 5 depicts a battery powered electronic device 502 in accordance with an embodiment in back view and side view having an empty battery holder 510. The battery holder 510 has two inside walls 524, 525. On the side walls 524, 525, elongate connectors 509 are configured to receive c-clip contacts on a battery.

FIG. 6 depicts two view of a battery 602 in accordance with an embodiment having c-clip contacts 604, 605. The first view shows its bottom side facing up on the drawing and the second view is a side view. The battery 602 depicted in FIG. 6 is configured with a first c-clip 604 to make surface contact with an inside wall of the battery holder. An optional second c-clip 605 is also illustrated. The c-clip may be on either lateral side of a battery 602.

In one embodiment, c-clips 604 can be single contact pairs that are separate contacts on the top of the slot and the bottom of the slot. Interconnects between contacts are shown in dashed outline in FIG. 6.

In another embodiment, the c-clip 605 is configured with redundant contact pairs for “make or break” (connecting or disconnecting of the battery to the electronic device) at the top of the slot and the bottom of the slot. Here the interconnects may also connect corresponding c-clip contacts at the top and bottom of the slot. It may be found that there is higher reliability inherent in a “c” shaped contact design, especially with redundant contact pairs as shown at 605. The higher reliability contacts can be used for plus and ground connections. In the c-clip embodiment, a mechanical latch or tab (not shown) can provide one way locking as well.

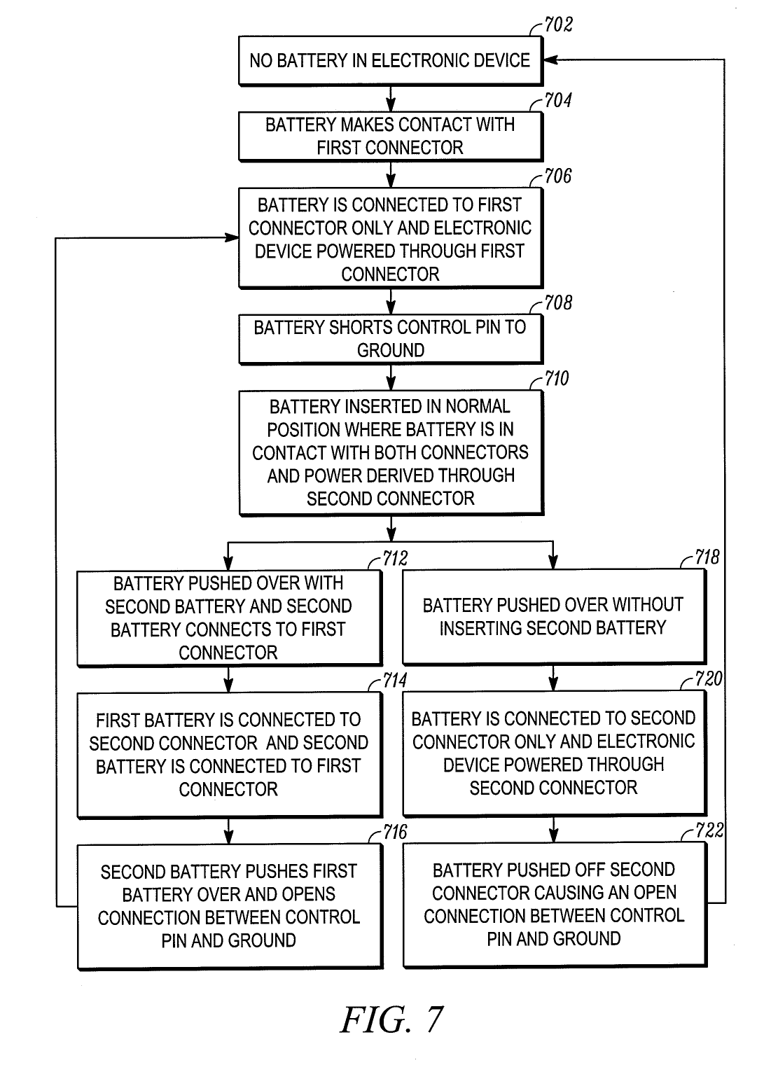

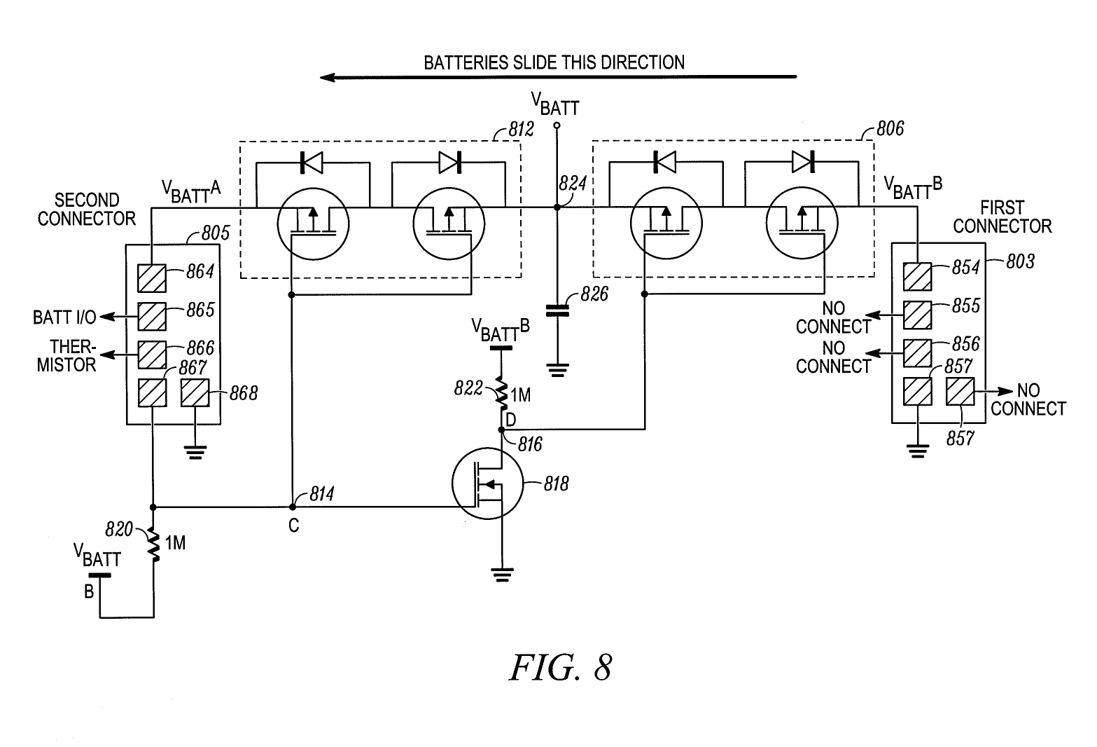

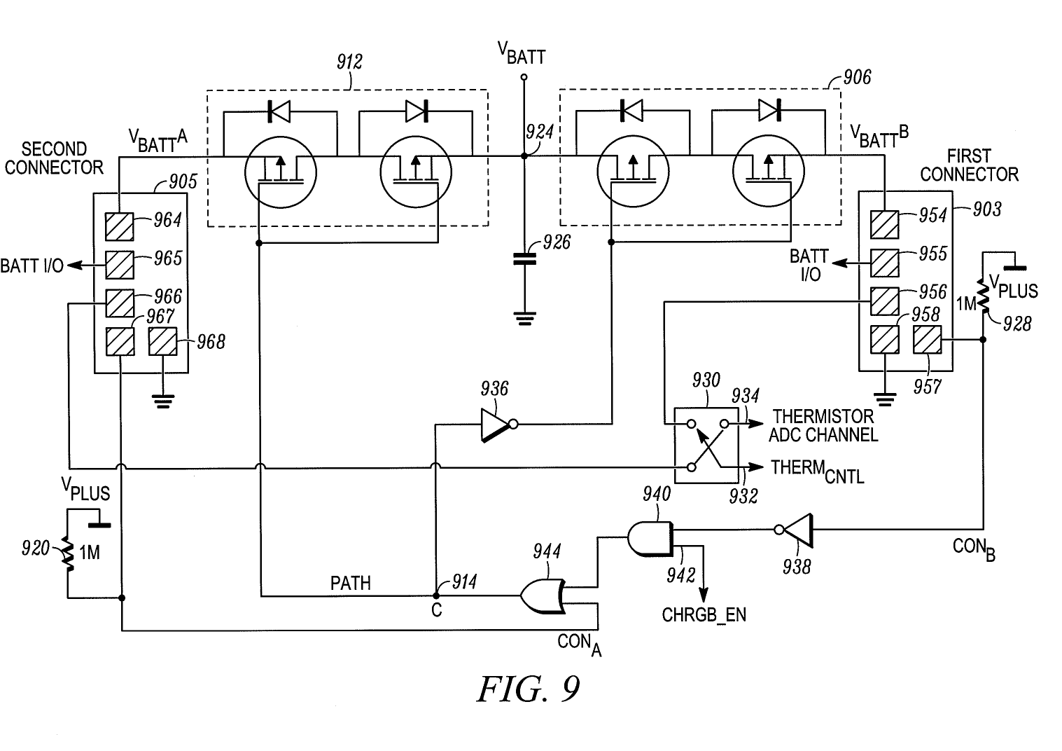

The following FIGS. 7, 8, and 9 refer to circuits for swapping batteries in the battery holders of the electronic devices according to various embodiments. FIG. 7 is a flowchart showing an embodiment of a process for making and breaking connections of the batteries' contacts to the connectors of the battery holder during swapping. FIG. 8 shows an embodiment of the connectors of the circuit of the battery holder along with other circuit components. FIG. 9 shows an embodiment of a circuit where logic components provide charger functions to one or two batteries in the device battery holder. It is understood that, although FIGS. 7, 8, and 9 will be described for a battery configured with elongate contacts, and its correspondingly configured battery holder, similar considerations apply for a battery configured with c-clip contacts and a correspondingly configured battery holder. It will further be understood that in the description of FIGS. 7, 8, and 9 below, the operation of the disclosed method and circuits does not depend on whether a battery has a configuration with elongate contacts or with c-clip contacts or any other suitable contact configuration.

The flowchart of FIG. 7 begins with no battery in the battery holder of the battery powered electronic device 702. In this circumstance, no voltage is supplied to the battery powered electronic device from a portable power source. Upon insertion of a battery into a battery holder, the battery contacts a first connector at step 704. The first connector includes a set of contacts, some of which draw power from the battery.

When the battery makes contact with the first connector only, the battery powered electronic device is powered by the battery through its contact with the first connector at step 706. As the battery moves into normal position in the battery holder, it makes contact with the second connector, and shorts a control pin to ground 708. In addition, some contacts of the second connector may monitor and alter the condition of the battery (for example by disabling charging or discharging of the battery). The battery connector circuit is configured so that when the control pin is shorted to ground, power can be drawn from the battery through the second connector at step 710. The elongate connectors of the first battery span both the first connector and the second connector of the battery holder at step 710.

Insertion of a second battery causes the first battery to be pushed off the first connector, remaining connected to the second connector. For a short time, neither battery may make contact with the first connector. Continued insertion of the second battery at step 712 results in the second battery making contact with the first connector while the first battery can continue to make contact with the second connector at step 714. If the first battery can make contact with the second connector, power may continue to be drawn from the first battery through the second connector.

With sufficient insertion of the second battery into the battery holder, the second battery pushes the first battery over and opens the connection between the control pin and ground at step 716. The first battery may no longer make electrical contact with either of the two battery connectors. At the same time, the second battery may continue to make contact with the first connector but may not yet have made contact with the second connector. Comparable to the situation discussed above in connection with step 706, the battery powered electronic device may be powered by the second battery through its contact with the first connector. Steps 708 and 710 may be executed to seat the second battery into the battery holder in a normal position. The first battery may be completely removed.

A different sequence of steps may be executed following step 710 than those described above. In a step 718, the first battery may be pushed over without insertion of a second battery. For example, a user may wish to gain access to a SIM module or other component accessible through the battery holder or battery compartment. One way latching may be configured so that the battery may be returned to a normal position after access to the SIM module, for example, is no longer needed. As a result of step 718, the battery may make contact with the second connector only, and the battery powered electronic device may be powered through the second connector 720. With continued pushing, the battery may be pushed off the second connector to break the connection between the control pin and ground 722. The battery may be removed from the battery powered electronic device, restoring the configuration of step 702.

FIG. 8 shows an embodiment of the connectors of the circuit in a battery holder along with other circuit components. The circuit of FIG. 8 provides power to the electronic device from connectors 803 and 805 in the following manner. The circuit includes a first connector 803 and a second connector 805 that can be configured to provide power to a battery powered electronic device from a first battery in contact with both the first connector 803 and the second connector 805 and from a substantially immediately subsequently positioned second battery to replace the first battery, the second battery in contact with the first connector 803 and the second connector 805. A charge source 826 is included for providing interim power to the circuit when the first battery is no longer in contact with the first connector 803 and before the second battery is in contact with the first connector 803. A switch 818 can also be included. The switch 818 is configured to couple the first connector 803 to the electronic device when the second battery is in contact with the first connector and the first battery is not in contact with the second connector 805, and to decouple the first connector when power is provided to the electronic device through battery contact with the second connector.

The following discussion provides more details of the circuit of FIG. 8. A first connector 803 includes five contacts 854, 855, 856, 857, 858 to make contact with elongate contacts of a battery such as battery 402 or battery 602. Contact 854 is connected to the first of a pair of back-to-back p-channel MOSFETs 806 in a common-drain configuration. Contacts 855, 856, and 857 are unconnected in this embodiment. Contact 858 is connected to ground in this embodiment.

A second connector 805 includes five contacts 864, 865, 866, 867, 868 to make contact with elongate contacts of a battery. Contact 864 is connected to the first of a pair of back-to-back p-channel MOSFETs 812 in a common-drain configuration, similar to the back-to-back MOSFETs 806. Contact 865 is connected to circuit components for data communication with a microprocessor and other circuitry that may be included with a battery. Similarly, contact 866 is connected to circuit components that may process output of a thermistor included with a battery. Contact 857 is a control pin connected to circuit components to control the back-to-back MOSFET pairs 806 and 812, as discussed below. Contact 858 is connected to ground.

For the purpose of discussing operation of a switch 818, two circuit nodes C and D are indicated at 814 and 816, respectively. The switch 818 may be a MOSFET or other suitable device operable as a switch. In FIG. 8, node C is connected to the gate of an n-channel MOSFET 818. Node D is connected to the drain of the MOSFET 818. The source of MOSFET 818 is connected to ground. As will be explained below, the value of the voltage of node C controls the value of the voltage of node D through the switch 818.

The previously mentioned pairs of back-to-back MOSFETs 806 and 812 each have their gates electrically connected together. MOSFET pair 806 has its gates together connected to node D. The value of the voltage of node D controls whether MOSFET pair 806 is in a conducting state or not, as explained below. MOSFET pair 812 has its gates together connected to node C. The value of the voltage of node C controls whether MOSFET pair 812 is in a conducting state or not.

Two pull-up resistors 820 and 822 with values of, for example, 1 mega ohm, are provided between the potential determined by contact 854, labeled VbattB in FIG. 8, and nodes C and D, respectively. The resistance values of 1 mega ohm are provided to limit the current drain on the battery during operation of the battery holder, and are not critical values. It is understood that their values may be selected to meet appropriate design conditions.

The circuit of FIG. 8 also includes a connection 824 labeled Vbatt between the two pairs of back-to-back p-channel MOSFETs 806 and 812. Vbatt is the voltage provided to the battery powered electronic device. A capacitor 826 is connected between connection 824 and ground. The capacitor, a charge source 826, can be included for providing interim power to the circuit when the first battery is not in contact with the first connector 803 and before the second battery is in contact with the first connector 803.

As mentioned above, operation of the circuit of FIG. 8 can be understood with reference to the steps described above with respect to FIG. 7. As described above, upon first insertion of a battery into the battery holder, the battery makes contact with the first connector 803. Assuming for the purpose of this discussion that the battery is charged, and has a potential of V1>0 volts, then contact 854, and hence VbattB, can have a potential of V1.

Contacts 867 and 868 are not connected together, since the battery is only partly inserted into the battery holder. Thus, no current flows through the resistor at 820 so that node C also has a potential of V1. Then the gate of n-channel MOSFET 818 is sufficiently positive with respect to its source to bring the MOSFET into conduction, driving node D substantially to ground potential. Current can flow through back-to-back p-channel MOSFETs 806 because the gate-source voltage drop there is sufficiently negative. Thus Vbatt, at connection 824, is substantially VbattB, and the battery powered electronic device is powered through the first connector 803.

With further insertion of the battery into the battery holder, the battery makes contact with the second connector 805. A contact of the battery shorts control pin contact 867 to ground contact 868. Shorting of the control pin to ground brings node C to ground potential, substantially turning off MOSFET 818 and therefore bringing node D to a potential of substantially VbattB. The gate-source voltage drop for MOSFET pair 806 may now be substantially zero, cutting off current flow through the MOSFET pair 806.

At substantially the same time that an elongate contact of the battery shorts control pin contact 867 to ground contact 868, another elongate contact of the battery may make electrical connection with contact 864. VbattA now has a non-zero value V1. The gate-source voltage drop of back-to-back p-channel MOSFET pair 812 can be negative, so MOSFET pair 812 can conduct. Thus Vbatt at connection 824 can be substantially VbattA, and the battery powered electronic device is powered through the second connector. The battery may be adjusted into its normal position, as discussed above in connection with step 710 of FIG. 7.

It is appreciated that capacitor 826 provides charge to connection 824 during the short time, if any, that neither MOSFET pair 806 nor MOSFET pair 812 is in a conducting state. Moreover, capacitor 826 may smooth abrupt changes in voltage during battery insertion and battery swaps. In this regard, it may function in this circuit as a low pass filter or power supply capacitor.

With insertion of a second battery, the first battery may be pushed off the first connector 803. The battery powered electronic device still can be powered by the first battery so long as control pin 867 is shorted to ground contact 868 and the potential V1 of the first battery is sufficiently positive. The battery powered electronic device may continue to be powered through the second connector until the first battery is pushed far enough out of the battery holder that connection between control pin 867 and ground contact 868 is broken. Once this happens, the situation is the same as previously described with a battery only partially inserted into the battery holder. It is appreciated that here too, capacitor 826 may act to provide charge to connection 824 and smoothing abrupt transitions in the voltage that may be otherwise supplied to the battery powered electronic device.

FIG. 9 shows another embodiment of the circuit where logic components provide charger functions to one or two batteries within the device battery holder. The described charger circuit may be for charging the first battery while the first battery is partially removed from the battery holder. The charging circuit further may be for charging the second battery while the second battery is partially received into the battery holder. The charging circuit includes logic to enable and prevent charging of the battery or batteries according to predetermined criteria. The logic is configured to provide charging to the first battery and/or charging to the second battery in either order or simultaneously.

Many of the components shown in FIG. 9 correspond to components previously discussed in connection with FIG. 8, and are numbered in FIG. 9 with corresponding numbers. As in the circuit of FIG. 8, the first connector 903 has five contacts 954, 955, 956, 957, 958 and the second connector 905 has five connectors 964, 965, 966, 967, 968. The pairs of back-to-back p-channel MOSFETs 906 and 912 are connected to their respective battery connectors 903 and 905 at contacts 954 and 964. The MOSFET pairs are connected together to connection 924, from which a capacitor 926 is connected to ground. Pull-up resistor 920 serves a similar function in the circuit of this embodiment as does the corresponding resistor in the embodiment of FIG. 8. A node C, labeled 914, corresponds to the similarly labeled node C of the circuit of FIG. 8, and is connected in common to the gates of the pair of back-to-back p-channel MOSFETs 912.

One difference with FIG. 8 lies in the connection of contact 955 with battery I/O circuitry, that is, contact 955 is connected to circuit components for data communication with a microprocessor and other circuitry that may be included with a battery for, as an example, safety and anti-counterfeiting measures. Similarly, contact 956 is connected to circuit components that may process output of a thermistor included with a battery to assist in charging the battery. In addition, contact 957 serves as a control pin coupled to logic to control the operation of the circuit, as described below. Pull-up resistor 928 is analogous to pull-up resistor 920, previously described.

Additional circuit components provide logic configured to control the operation of the circuit, that is, whether power is to be supplied to the battery powered electronic device through the first battery connector 903 or through the second battery connector 905. Many of these circuit components can accept input or supply output whose values may be considered as logic levels, this is, 0 or 1, and denoted in uppercase. The additional components include a single-pole double-throw switch 930 coupled to contacts 956 and 966 for thermistor output. The switch is controlled through a control line 932 whose logic level is denoted THERMCNTL, and its output provided on an output line 934 to a thermistor analog-to-digital converter (ADC) channel.

An inverter 936 with its input connected to node C supplies output to the commonly connected gates of the pair of back-to-back p-channel MOSFETs 906. Inverter 936 can provide similar switch functionality as switch 818 in the circuit of FIG. 8. An inverter 938 with its input coupled to control pin 957 supplies its output to an AND gate 940. The logic level of the input to inverter 938 is denoted CONB in FIG. 9. A second input to the AND gate is supplied by a charge enable line 942, whose logic level is denoted CHRGB_EN. Output from the AND gate is one input to an OR gate 944. A second input to the OR gate is coupled to control pin 967, and its logic level is denoted CONA in FIG. 9. The OR gate output is connected to node C, and its logic level is denoted PATH in the figure. A manner in which these components work together to control the supply of power to the battery powered electronic device through the first battery connector 903 or through the second battery connector 905 is described below.

The charge enable line 942 provides for selection of battery to charge, when two batteries are in the battery holder and a charger is connected to the battery powered electronic device. When CHRGB_EN has a value of 0, a battery making contact with the second connector can be charged. If a battery makes contact with the first connector, but no battery makes contact with the second connector, the battery can be charged through the first connector. When CHRGB_EN is 1, the battery connected to the first connector can be charged. If no battery is connected to the first connector, a battery connected to the second connector can be charged.

CONA, CONB, PATH, and CHRGB_EN together provide a description of circuit operation, shown in the following truth table.

| Inputs | | | Output | |
|---|---|---|---|---|
| CONA | CONB | CHRGB_EN | PATH | Note |
| 0 | 0 | 0 | 0 | Ready to power Device |
| | | | | Through 2^{nd} Connector |
| 0 | 0 | 1 | 1 | Power Device Through |
| | | | | 1^{st} Connector |
| 0 | 1 | 0 | 0 | Power Device Through |
| | | | | 2^{nd} Connector |
| 0 | 1 | 1 | 0 | Power Device Through |
| | | | | 2^{nd} Connector |
| 1 | 0 | 0 | 1 | Power Device Through |
| | | | | 1^{st} Connector |
| 1 | 0 | 1 | 1 | Power Device Through |
| | | | | 1^{st} Connector |
| 1 | 1 | 0 | 1 | Power Device Through |
| | | | | 1^{st} Connector |
| 1 | 1 | 1 | 1 | Power Device Through |
| | | | | 1^{st} Connector |

It is understood that CONA has a value 0 when control pin 967 is shorted to ground contact 968 and has a value of 1 otherwise, and CONB likewise has a value 0 when control pin 957 is shorted to ground contact 958 and has a value of 1 otherwise. Thus, if contacts of a single battery span both the first connector 903 and the second connector 905, CONA and CONB can both be 0. The behavior of the circuit depends on the value of CHRGB_EN. If CHRGB_EN is 0 and CONA is 0, then PATH is 0 so that back-to-back p-channel MOSFETs 912 conduct. Because of inverter 936, back-to-back p-channel MOSFETs 906 do not conduct. Thus, the battery powered electronic device may be powered through the second connector 905.

If CHRGB_EN is 1 and both CONA and CONB are 0, then PATH has a value of 1 so that back-to-back p-channel MOSFETs 912 do not conduct. Because of inverter 936, back-to-back p-channel MOSFETs 906 conduct. The battery powered electronic device is then powered through the first connector 903.

In the case where no battery makes contact with the first connector 903, but contact is made with the second connector 905, CONA is 0, CONB is 1, and PATH is 0. The battery powered electronic device therefore is powered through the second connector 905. In the case where no battery makes contact with the second connector 905, but contact is made with the first connector 903, CONA is 1, CONB is 0, and PATH is 1. The battery powered electronic device can then be powered through the first connector 903.

When no battery makes contact with either the first connector or the second connector (CONA is 0 and CONB is 0), then PATH is 0 and the electronic device is ready to be powered through the second connector after a battery is inserted.

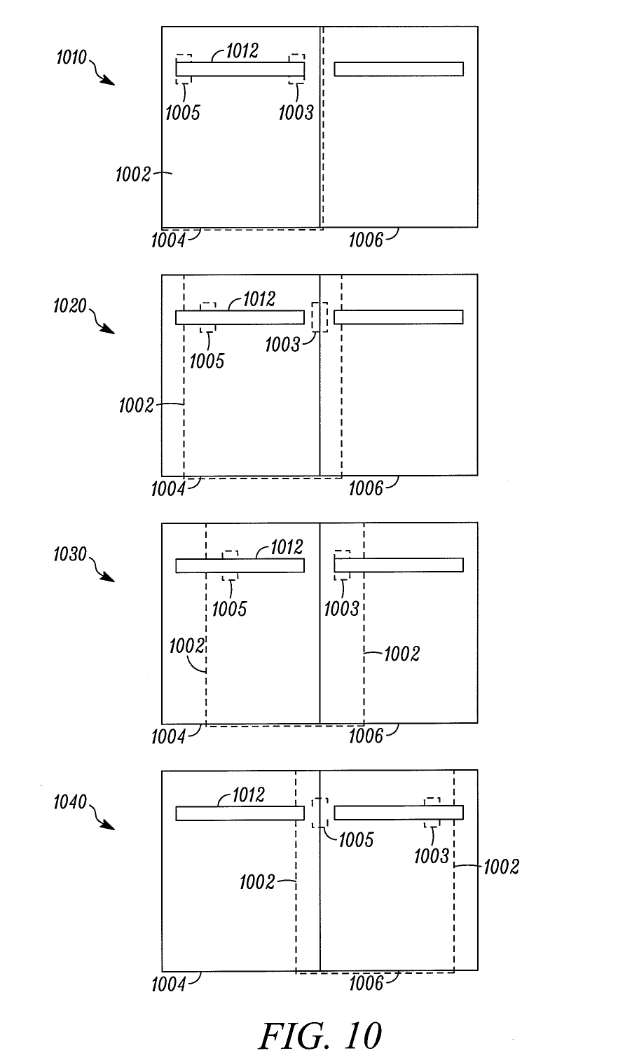

FIG. 10 shows schematically four configurations where the battery holder 1002 and the two battery connectors 1003, 1005 are shown in dashed outline to summarize positions of the battery holder 1002 that one or two batteries may occupy. In a first battery configuration 1010, a first battery 1004 is in the battery holder 1002, with its elongate contacts 1012 spanning the two battery connectors 1003, 1005 in the battery holder 1002. A second battery 1006 is shown ready for insertion into the battery holder. In a second battery configuration 1020, the second battery 1006 has been partially inserted into the battery holder 1002, far enough to push the first battery 1004 off the first connector 1003, but not far enough that the second battery 1006 has made contact with the first connector 1003. In the second battery configuration 1020, the elongate contacts 1012 of the first battery 1004 continue to make contact with the second connector 1005.

In a third battery configuration 1030, the second battery 1006 has been inserted far enough into the battery holder 1002 that it makes contact with the first connector 1003, and the first battery 1004 elongate contacts 1012 continue to make contact with the second connector 1005. In the fourth battery configuration 1040, the elongate contacts 1012 of the first battery 1004 have broken contact with the second connector 1005, and the second battery 1006 continues to make contact with the first connector 1003 but has not yet made contact with the second connector 1005. Finally, when the second battery 1006 is fully inserted (not shown) it can make normal contact with both connectors 1003 and 1005.

It is understood that, although FIG. 10 has been described for a battery configured with elongate contacts and its correspondingly configured battery holder, similar considerations apply for a battery configured with c-clip contacts and a correspondingly configured battery holder. It will further be understood that in the description of FIGS. 7-9 above, the operation of the disclosed method and circuits does not depend on whether a battery may have a configuration with elongate contacts or with c-clip contacts or any other suitable contact configuration.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method in a battery powered electronic device having a battery holder with a first connector and a second connector, the battery powered electronic device having a first battery in contact with both the first connector and the second connector, the method comprising:
maintaining power to the device from the first battery;
partially moving the first battery out of the battery holder in a predetermined direction to break contact with the first connector while maintaining contact with the second connector; and
partially inserting a second battery into the battery holder in the predetermined direction so that the second battery is received by the battery holder and makes contact with the first connector.

2. The method of claim 1, further comprising:
charging the first battery through the second connector.

3. The method of claim 1, further comprising:
charging the second battery through the first connector.

4. The method of claim 1, wherein:
partially moving the first battery comprises sliding the first battery; and
partially inserting the second battery comprises sliding the second battery.

5. The method of claim 1, wherein partially inserting the second battery comprises:
moving the second battery in the predetermined direction within the battery holder so that it pushes the first battery in the predetermined direction to effect the partially moving of the first battery.

6. The method of claim 1, further comprising:
removing in the predetermined direction the first battery from the battery holder so that the first battery breaks contact with the second connector;
maintaining power to the device from the second battery; and
positioning the second battery in the battery holder so that the second battery makes contact with both the first connector and the second connector.

7. A system for maintaining power in a battery powered electronic device during removal of a first battery and installation of a second battery, the system comprising:
the battery powered electronic device comprising a first connector and a second connector having a distance therebetween in a battery holder that is adapted to allow partial removal of the first battery in a predetermined direction from the battery holder while receiving power from the first battery and that is adapted to allow a substantially sequentially receipt of the second battery in the predetermined direction to partially receive the second battery in the battery holder;
the first battery having contacts configured to provide power to the first connector and the second connector; and
the second battery having contacts configured to provide power to the first connector and the second connector.

8. The system of claim 7, wherein:
the first battery comprises elongate contacts that span the distance between the first connector and the second connector when the first battery is fully positioned in the battery holder; and
the second battery comprises elongate contacts that span the distance between the first connector and the second connector when the second battery is fully positioned in the battery holder.

9. The system of claim 7, wherein:
the first battery has a bottom side configured to make substantial contact with the battery holder, and the contacts of the first battery are elongate contacts on the bottom side of the first battery; and
the second battery has a bottom side configured to make substantial contact with the battery holder, and the contacts of the second battery are elongate contacts the bottom side of the second battery.

10. The system of claim 7, wherein:
the first battery has a lateral side configured to make surface contact with an inside wall of the battery holder, and a contact of the first battery is an elongate first contact on the lateral side of the first battery; and
the second battery has a lateral side configured to make surface contact with an inside wall of the battery holder, and a contact of the second battery is an elongate second contact on the lateral side of the second battery.

11. The system of claim 10, wherein:
the first battery has an opposite lateral side, and a contact of the first battery is an elongate third contact on the opposite lateral side of the first battery; and
the second battery has an opposite lateral side, and a contact of the second battery is an elongate fourth contact on the opposite lateral side of the second battery.

12. The system of claim 7, wherein:
the first battery comprises c-clip contacts that are configured to make contact with the first connector and the second connector that are located on inside walls of the battery holder; and
the second battery comprises c-clip contacts that are configured to make contact with the first connector and the second connector that are located on inside walls of the battery holder.

13. The system of claim 12, wherein:
the first connector of the battery holder is an elongate first connector; and
the second connector of the battery holder is an elongate second connector.

14. The system of claim 7, wherein the battery holder is further adapted to provide mechanical latching to engage the first battery in the predetermined direction and to engage the second battery in the predetermined direction.

15. The system of claim 7, the battery powered electronic device further comprising:
a circuit comprising a charge source adapted to maintain power to the battery powered electronic device when the first battery is partially removed from the battery holder and the second battery is partially received by the battery holder.

16. The system of claim 7 further comprising:
a charger circuit for charging the first battery while the first battery is partially removed from the battery holder, and for charging the second battery while the second battery is partially received into the battery holder.

17. A circuit, comprising:
a first connector and a second connector configured to provide power to an electronic device from a first battery initially in contact with the first connector and the second connector and from a substantially immediately subsequently positioned second battery to replace the first battery, the second battery in contact with the first connector and the second connector;
a charge source for providing interim power to the circuit when the first battery is not in contact with the first connector and before the second battery is in contact with the first connector; and
a switch configured to couple the first connector to the electronic device when the second battery is in contact with the first connector and the first battery is not in contact with the second connector, and to decouple the first connector when power is provided to the electronic device through battery contact with the second connector.

18. The circuit of claim 17, further comprising a battery charger coupled to the first connector and to the second connector.

19. The circuit of claim 18, further comprising logic to enable and prevent charging of the first battery and the second battery according to predetermined criteria.

20. The circuit of claim 18 further comprising logic to enable charging of the first battery.

21. The circuit of claim 18 further comprising logic to enable charging of the second battery.

22. A battery comprising:
contacts configured to make contact simultaneously with at least two sets of battery connectors of an electronic device having at least one of an elongate contact configuration and a c-clip configuration.
